(19) United States
(12) Patent Application Publication
(10) Pub. No.: US 2015/0099623 A1
(43) Pub. Date: Apr. 9, 2015

(54) OXIDE FILM AND PROTON CONDUCTIVE DEVICE

(71) Applicant: Panasonic Corporation, Osaka (JP)

(72) Inventors: TAKASHI NISHIHARA, Osaka (JP); YUJI ZENITANI, Nara (JP); TETSUYA ASANO, Kyoto (JP); AKIHIRO ITOH, Kyoto (JP); TOMOYUKI KOMORI, Osaka (JP); HIDEAKI ADACHI, Osaka (JP); EIJI FUJII, Osaka (JP)

(21) Appl. No.: 14/499,817

(22) Filed: Sep. 29, 2014

(30) Foreign Application Priority Data
Oct. 8, 2013 (JP) 2013-210678
Dec. 19, 2013 (JP) 2013-262004

(51) Int. Cl. C25B 11/04; H01M 4/90

(52) U.S. Cl. CPC C25B 11/04; H01M 4/9016; H01M 4/9075
USPC 502/303; 502/302; 502/304

(57) ABSTRACT

The present invention provides an oxide film composed of an oxide having a perovskite crystal structure. The oxide is represented by a chemical formula A₁₋ₓ(E_{1-y}G_{y})O_{z}. A represents at least one element selected from the group consisting of Ba, Sr, and Ca. E represents at least one element selected from the group consisting of Zr, Hf, In, Ga, and Al. G represents at least one element selected from the group consisting of Y, La, Ce, and Gd. All of the following five mathematical formulae are satisfied: 0.2≦x≦0.5, 0.1≦y≦0.7, z<3, 0.3890 nanometers≦a≦0.4190 nanometers, 0.95≦a/c<0.98. Each of a, b and c represents a lattice constant of the perovskite crystal structure. Either the following mathematical formula is satisfied: a≦b<c or a<b≦c.

### BACKGROUND

1. Technical Field

The present invention relates to an oxide film having proton conductivity.

2. Description of the Related Art

U.S. Pat. No. 6,528,195 discloses a mixed ionic conductor with an ion conductive oxide has a perovskite structure of the formula Ba_{d}Zr_{1-x-y}CeₓM_{y}³O_{3-y} wherein M³ is at least one element selected from the group consisting of Sm, Eu, Gd, Tb, Yb, Y, Sc, and In; with 0.98≦d≦1; 0.01≦x<0.5; 0.01≦y≦0.3; (2+y−2d)/2≦y<1.5. Such a mixed ionic conductor has not only the necessary conductivity for electrochemical devices such as fuel cells, but also superior moisture resistance.

### SUMMARY

The present invention provides an oxide film composed of an oxide having a perovskite crystal structure, wherein

the oxide is represented by a chemical formula A₁₋ₓ(E_{1-y}G_{y})O_{z};

where

A represents at least one element selected from the group consisting of Ba, Sr, and Ca;

E represents at least one element selected from the group consisting of Zr, Hf, In, Ga, and Al;

G represents at least one element selected from the group consisting of Y, La, Ce, and Gd; and

all of the following five mathematical formulae (I)-(V) are satisfied:

0.2≦x≦0.5 (I)

0.1≦y≦0.7 (II)

z<3 (III)

0.3890 nanometers≦a≦0.4190 nanometers (IV)

0.95≦a/c<0.98 (V)

where

each of a, b and c represents a lattice constant of the perovskite crystal structure; and

either the following mathematical formula (VIa) or (VIb) is satisfied:

a≦b<c (VIa)

a<b≦c (VIb).

The present invention further provides a proton conductor, comprising:

a single-crystalline substrate; and

an oxide film disposed on or above the single-crystalline substrate, wherein

the above-mentioned oxide film.

The present invention still further provides a proton conductor, comprising:

an oxide film; and

a proton-permeable or gas-permeable conductive material provided on at least one surface of the oxide film, wherein

the above-mentioned oxide film.

The oxide film according to the present invention has good proton conductivity even at 200 degrees Celsius.

### BRIEF DESCRIPTION OF THE DRAWINGS

FIG. 1 shows a cross-sectional view of a proton conductive device comprising an oxide film according to a first embodiment;

FIG. 2A shows a schematic view of the oxide film having a perovskite crystal structure;

FIG. 2B shows a schematic view of the crystal structure of the oxide film affected by compression strain;

FIG. 2C shows a schematic view of the crystal structure of the oxide film affected by tensile strain;

FIG. 3 shows a cross-sectional view of another proton conductive device comprising the oxide film according to the first embodiment;

FIG. 4 shows a cross-sectional view of still another proton conductive device comprising the oxide film according to the first embodiment;

FIG. 5A shows one step included in a method for fabricating the oxide film according to the first embodiment;

FIG. 5B shows one step subsequent to FIG. 5A included in the method for fabricating the oxide film according to the first embodiment;

FIG. 5C shows one step subsequent to FIG. 5B included in the method for fabricating the oxide film according to the first embodiment;

FIG. 5D shows one step subsequent to FIG. 5C included in the method for fabricating the oxide film according to the first embodiment, wherein the oxide film is affected by compression strain;

FIG. 5E shows one step subsequent to FIG. 5C included in the method for fabricating the oxide film according to the first embodiment, wherein the oxide film is affected by tensile strain;

FIG. 6 shows a cross-sectional view of a proton conductive device according to a second embodiment;

FIG. 7 shows a schematic view of a method for measuring the electric conductivity of the oxide film according to the inventive examples 1-21 and the comparative examples 1-3;

FIG. 8 shows a schematic view of a method for measuring the electric conductivity of the oxide film according to the inventive example 22 and the comparative example 4;

FIG. 9 shows a graph showing a relation between the lattice constant a and the value of a/c of the oxide films according to the inventive examples and the comparative examples;

FIG. 10 shows a graph showing a result of an X-ray diffraction analysis in the inventive example 1; and

FIG. 11 shows a graph showing a relation between the temperature and the proton conductivity in the inventive example 2.

### DETAILED DESCRIPTION OF THE EMBODIMENTS

Hereinafter, the embodiments of the present invention will be described with reference to the drawings.

### First Embodiment

The oxide film according to the first embodiment is described below.

The oxide film according to the first embodiment is an oxide film composed of an oxide having a perovskite crystal structure.

The oxide is represented by a chemical formula A₁₋ₓ(E_{1-y}G_{y})O_{z}.

A represents at least one element selected from the group consisting of Ba, Sr, and Ca. Ba is desirable.

E represents at least one element selected from the group consisting of Zr, Hf, In, Ga, and Al. It is desirable that E includes Zr. In other words, desirably, E is selected from the group consisting of Zr, ZrHf, ZrIn, ZrGa, and ZrAl.

G represents at least one element selected from the group consisting of Y, La, Ce and Gd. It is desirable that G includes Y. In other words, desirably, G is selected from the group consisting of Y, YLa, YCe and YGd. It is also desirable that G is CeAl.

In the first embodiment, all of the following five mathematical formulae (I)-(V) are satisfied:

0.2≦x≦0.5 (I)

0.1≦y≦0.7 (II)

z<3 (III)

0.3890 nanometers≦a≦0.4190 nanometers (IV)

0.95≦a/c<0.98 (V)

where

each of a, b and c represents a lattice constant of the perovskite crystal structure, and

either the following mathematical formula (VIa) or (VIb) is satisfied:

a≦b<c (VIa)

a<b≦c (VIb).

In a case where the mathematical formula (I) fails to be satisfied, namely, when x is less than 0.2, the oxide film has a low proton conductivity at 200 degrees Celsius. In this case, the oxide film has high activation energy for proton conductivity. See the comparative example 1, the comparative example 3, and the comparative example 4, which will be described later.

In a case where x is more than 0.5, the crystal structure of the oxide film is chemically unstable.

Desirably, the following mathematical formula (Ia) is satisfied.

0.1≦x≦0.5 (Ia)

More desirably, the following mathematical formula (Ib) is satisfied.

0.3≦x≦0.5 (Ib)

When the mathematical formula (Ib) is satisfied, an oxide film 102 exhibits higher proton conductivity.

Since an A site has a lattice defect, the elements of the A site are prevented from being precipitated at a crystal grain boundary. For example, when Ba is precipitated at the crystail grain boundary, Ba reacts with water included in the air to form barium hydroxide. Furthermore, barium hydroxide reacts with carbon dioxide to precipitate barium carbonate. The precipitation of barium carbonate causes the characteristic deterioration of the oxide film 102. When the A site has a lattice defect, Ba is prevented from being precipitated at the crystal grain boundary.

The value of y represents a substitution content of a trivalent metal in a B site. The value of y also represents a ratio of oxygen defects in the oxide represented by the chemical formula A₁₋ₓ(E_{1-y}G_{y})O_{z}.

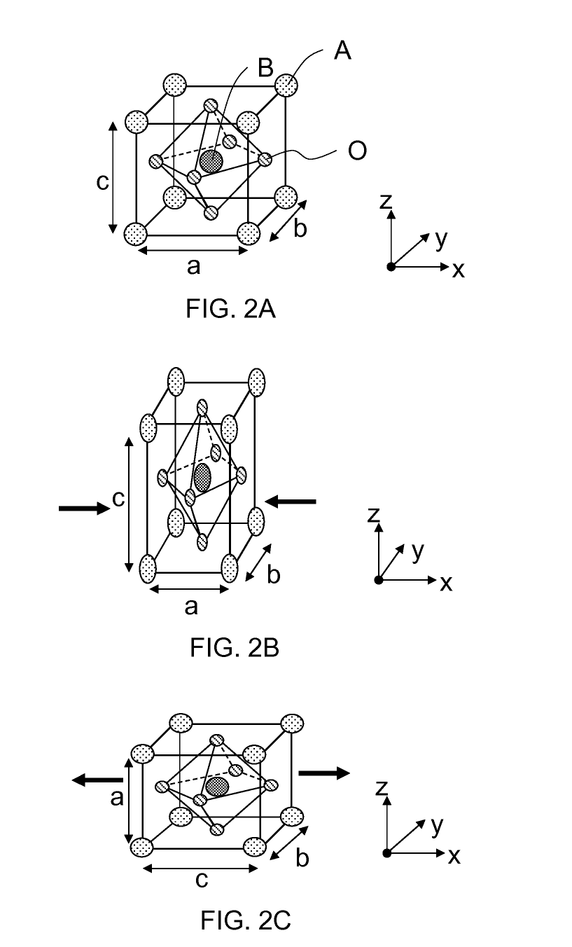

A perovskite type oxide (hereinafter, referred to as “oxide”) is generally represented by a chemical formula of ABO₃, and has a unit cell of a cubic system. FIG. 2A shows a schematic view of the perovskite crystal structure. As shown in FIG. 2A, an alkaline earth metal atom such as Ba, Sr, or Ca is arranged at the A sites which are corners of the cubical crystal. A metal atom selected from the group consisting of Zr, Hf, Y, La, Ce, Gd, In, Ga, and Al is arranged at the B site which is a body center of the cubical crystal. Oxygen atoms are arranged at face centers of the cubical crystal. When the B sites are occupied only with tetravalent metal atoms, the perovskite crystal structure is free from oxygen defects. On the other hand, when the B sites include trivalent metal atoms, the perovskite crystal structure contains as much oxygen defects as the number of the atoms of the trivalent metal. These oxygen defects give proton conductivity to the oxide.

When the value of y is less than 0.1, the oxide film fails to have sufficient proton conductivity.

When the value of y is more than 0.7, the crystal structure of the oxide film is chemically unstable.

The value of y represents a substitution content of a trivalent metal in the B site. The value of y also represents a ratio of oxygen defects in the oxide represented by the chemical formula A₁₋ₓ(E_{1-y}G_{y})O_{z}. When the mathematical formula (II) is satisfied, the oxide exhibits good proton conductivity. In particular, the oxide exhibits good proton conductivity under a temperature of 200 degrees Celsius. A proton conductor composed of a conventional oxide is generally used under a temperature of 600 degrees Celsius-700 degrees Celsius. The proton conductor composed of the conventional oxide exhibits low proton conductivity under a temperature of 200 degrees Celsius. See the comparative examples 1-4.

Desirably, the following mathematical formula (IIa) is satisfied.

0.3≦y≦0.5 (IIa)

The mathematical formula (III) means that the oxide represented by the chemical formula A₁₋ₓ(E_{1-y}G_{y})O_{z} has oxygen defects since the A site has lattice defects and a part of the tetravalent metal atoms included in the B site are substituted with the trivalent metal atoms.

Specifically, the value of z is represented by the following mathematical formula (x).

z=3−x−w/2 (x)

where w represents a substitution content of the trivalent metal (B 3) with regard to the tetravalent metal (B4) in the elements contained in the B site. The oxide represented by the chemical formula A₁₋ₓ(E_{1-y}G_{y})O_{z} may be represented by A₁₋ₓB4_{1-w}B3_{w}O_{z}. For example, one of the oxides represented by the chemical formula A₁₋ₓ(E_{1-y}G_{y})O_{z} is Ba_{0.5}Zr_{0.8}Y_{0.2}O_{z}. Since x=0.5 and w=0.2, z is equal to 2.4. It is desirable that z is in the range of z≦2.5. A small stoichiometric mismatch should be permitted.

Even if all of the three mathematical formulae (I), (II), and (III) are satisfied, both of the two mathematical formulae (IV) and (V) have to be satisfied. In case where at least one of the two mathematical formulae (IV) and (V) is satisfied, the oxide film has low proton conductivity at a temperature of 200 degrees Celsius, similarly to the case where x=0. Furthermore, such an oxide film has high activation energy for proton conductivity. See the comparative example 2 which will be described later.

Needless to say, even if both of the two mathematical formulae (IV) and (V) are satisfied, in a case where not all of the three mathematical formulae (I), (II), and (III) are satisfied, the oxide film has low proton conductivity at 200 degrees Celsius. Furthermore, the oxide film has high activation energy for proton conductivity. See the comparative example 3 which will be described later.

In the cubical crystal free from strain, the lattice constants a, b, and c are equivalent to one another. Theoretically, the mathematical formula a=b=c is satisfied. On the other hand, when the perovskite crystal structure is deformed in a predetermined direction, the deformed perovskite crystal structure has a tetragonal system or a rhombic system. As a result, at least one lattice constant of the three lattice constants a, b, and c is different from the two other lattice constants. Hereinafter, in the present specification, an a-axis and a c-axis are respectively set to be the shortest and the longest lattices from among the lattice constants a, b, and c in the tetragonal system or rhombic system. In other words, either the following mathematical formula (VIa) or (VIb) is satisfied.

a≦b<c (VIa)

a<b≦c (VIb)

FIG. 2B shows a case where the mathematical formula (VIa) is satisfied. In FIG. 2B, the perovskite crystal structure has a (001) orientation. FIG. 2C shows a case where the mathematical formula (VIb) is satisfied. In FIG. 2C, the perovskite crystal structure has a (100) orientation.

As shown in FIG. 2B, the oxide represented by the chemical formula A₁₋ₓ(E_{1-y}G_{y})O_{z} has a crystal structure in which the lattice intervals are compressed along the a-axis and the b-axis whereas the lattice interval is extended along the c-axis. Instead, as shown in FIG. 2C, the oxide represented by the chemical formula A₁₋ₓ(E_{1-y}G_{y})O_{z} has a crystal structure in which the lattice interval is compressed along the a-axis whereas the lattice intervals are extended along the b-axis and the c-axis.

In the case shown in FIG. 2B, since the lattice intervals are compressed along the a-axis and the b-axis, the proton conductivity improves along the a-axis direction and the b-axis direction. On the other hand, in the case shown in FIG. 2C, since the lattice interval is compressed along the a-axis, the proton conductivity improves along the a-axis direction.

The values of the lattice intervals a, b, and c are identified using an X-ray diffraction device and a transmission electron microscope.

Desirably, both of the following two mathematical formulae (IVa) and (Va) are satisfied.

0.3890 nanometers≦a≦0.4040 nanometers (IVa)

0.95≦a/c<0.975 (Va)

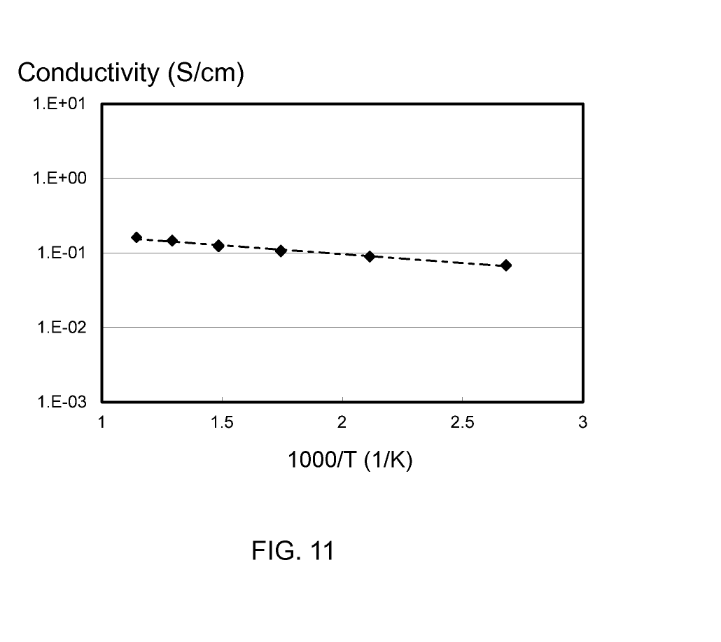

Since both of the two mathematical formulae (IV) and (V) are satisfied, the oxide film according to the first embodiment exhibits the high proton conductivity even under a temperature of 200 degrees Celsius. Furthermore, in the oxide film according to the first embodiment, the temperature dependence of the proton conductivity is small. In other words, in the oxide film according to the first embodiment, the activation energy for the proton conduction is small. See FIG. 11 which shows the inventive examples 2 and its result. As a result, the oxide film having the good proton conductivity within a large temperature range is realized.

When A includes Ba, the lattice constant of the oxide is increased. On the other hand, when A includes Sr or Ca, the lattice constant of the oxide is decreased. When E includes Zr, the durability of the oxide under a reducing atmosphere is improved.

Desirably, the oxide film may have a thickness of not more than 5 micrometers. More desirably, the oxide film may have a thickness of not more than 2 micrometers.

Next, a method for fabricating the oxide film represented by the chemical formula A₁₋ₓ(E_{1-y}G_{y})O_{z} will be described with reference to the drawings. A proton conductor comprising the oxide film represented by the chemical formula A₁₋ₓ(E_{1-y}G_{y})O_{z} will also be described.

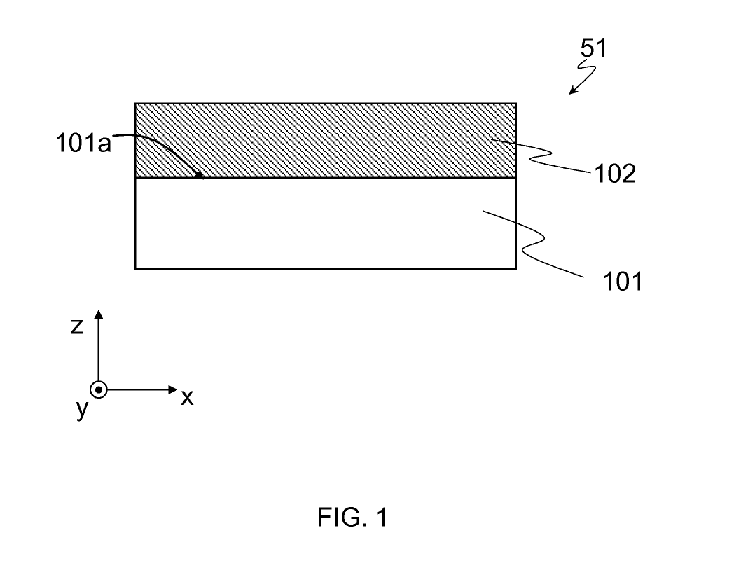

FIG. 1 shows a cross-sectional view of a proton conductor 51 comprising the oxide film 102 according to the first embodiment. The proton conductor 51 comprises a substrate 101 and the oxide film 102 disposed on the substrate 101. The oxide film 102 is supported on the substrate 101. A method for fabricating the proton conductor 51 will be described below.

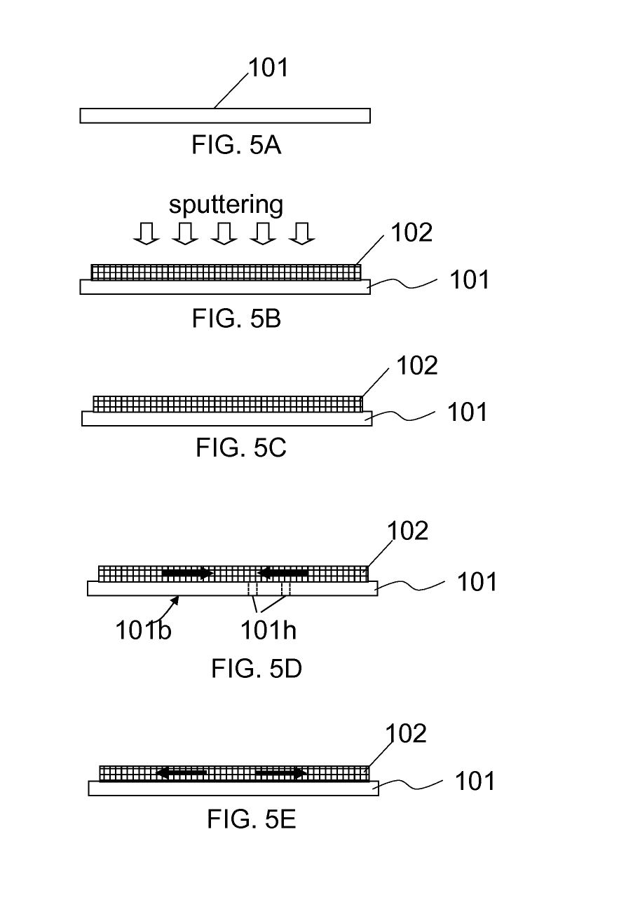

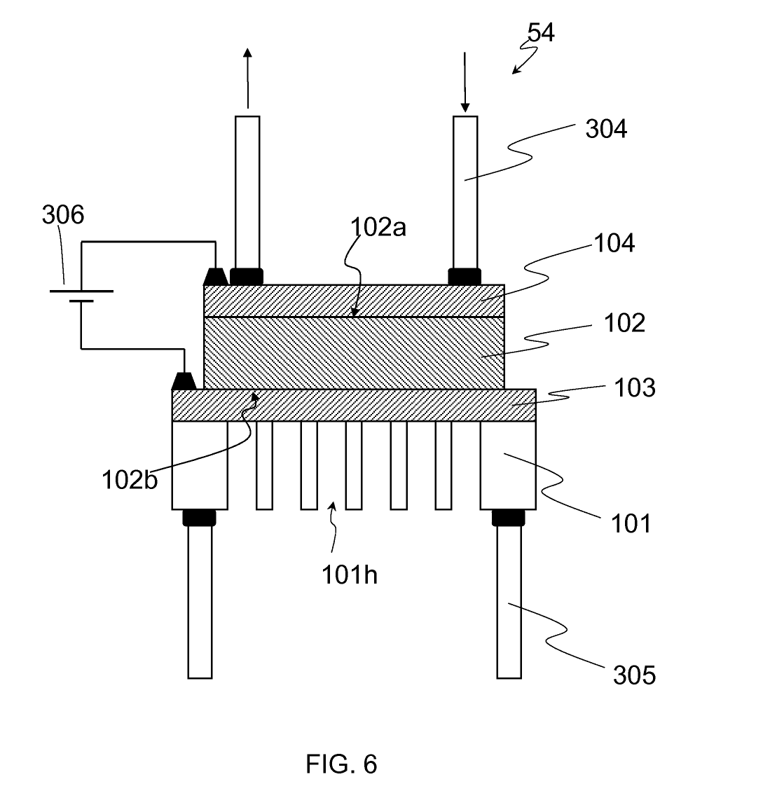

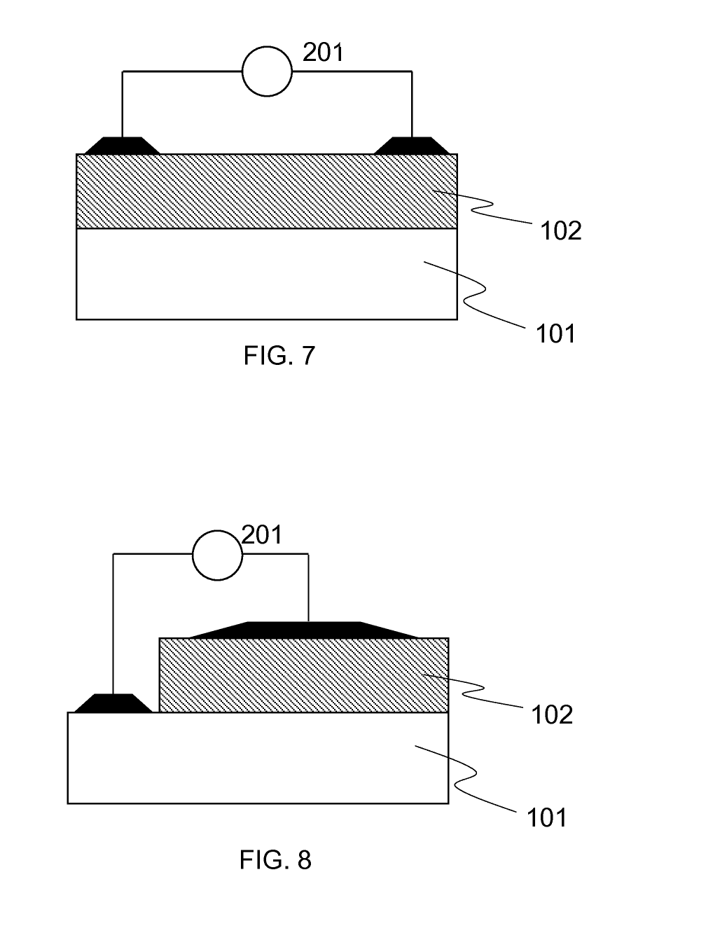

First, as shown in FIG. 5A, the substrate 101 is prepared. An example of the substrate 101 is a single-crystalline MgO substrate or a silicon substrate. It is desirable that the surface of the substrate 101 has been polished to a mirror gloss. A specific single-crystalline MgO substrate has a thickness of 0.5 millimeters, a diameter of 2 inches, and a (100) orientation. A specific silicon substrate has a thickness of 0.5 millimeters, a diameter of 2 inches, a (100) orientation, and a specific resistance of 0.01 Ω·cm.

The substrate 101 has a principal plane 101a.

The linear expansion coefficient of the substrate 101 affects the linear expansion coefficient of the oxide film 102. The substrate 101 is composed of a material having a higher or lower linear expansion coefficient than the material which constitutes the oxide film 102.

As one example, the substrate 101 may be formed of a material having a linear expansion coefficient of not less than 1×10⁻⁶/K and not more than 4×10⁻⁶/K. An example of such a material of the substrate 101 is Si, SiC, or Si₃N₄. The linear expansion coefficient of the single-crystalline silicon substrate is 2.6×10⁻⁶/K. In this case, the oxide film 102 may have a higher linear expansion coefficient than the substrate 101. For example, the oxide film 102 has a linear expansion coefficient of approximately 7×10⁻⁶/K. When the principal plane 101a has a (100) plane, the oxide film 102 having the high crystallinity is obtained easily.

The substrate 101 may be formed of a material having a linear expansion coefficient of not less than 1×10⁻⁵/K and not more than 2×10⁻⁵/K. An example of such a material of the substrate 101 is MgO, ZrO₂, LaAlO₃, Ni, or stainless steel. The single-crystalline MgO substrate has a linear expansion coefficient of 1.3×10⁻⁵/K. In this case, the oxide film 102 may have a smaller linear expansion coefficient than the substrate 101. When the principal plane 101a has a (100) plane, the oxide film 102 having the high crystallinity is obtained easily. Since a Si single crystal and a MgO single crystal belong to a cubic system, a (100) plane, a (010) plane, and a (001) plane are equivalent to one another.

Subsequently, as shown in FIG. 5B, the oxide film 102 is formed on the substrate 101. The oxide film 102 may be formed by a sputtering method under a noble gas atmosphere using a sputtering target consisting of an oxide which constitutes the oxide film 102 and an RF power supply. The used sputtering target may be formed of a compound represented by the chemical formula Ba_{0.8}Zr_{0.7}Y_{0.3}O_{2.65}. The noble gas may contain a reactant gas. An example of the reactant gas is at least one kind of gas selected from the group consisting of an O₂ gas, a N₂ gas, and a H₂ gas.

In order to raise the formation speed of the oxide film 102, the oxide film 102 may be formed by a sputtering method using a sputtering target containing a slight amount of a conductive material with a DC power supply or a pulse DC power supply.

The oxide film 102 may be formed by a reactive sputtering method using a sputtering target containing the metal A, the metal E, and the metal G under a gaseous mixture atmosphere of the noble gas and the reactant gas. In this case, a DC power supply, a pulse DC power supply, or an RF power supply may be used.

The oxide film 102 may be formed by sputtering simultaneously using a sputtering target containing the oxide of the elements contained in the oxide film 102 (e.g., BaO, ZrO₂, and Y₂O₃) together with a plurality of power supplies.

The oxide film 102 may be formed by sputtering simultaneously using two or more sputtering targets together with a plurality of power supplies. Even if these sputtering targets are used, the sputtering is conducted under a noble gas atmosphere. The noble gas may contain the reactant gas.

In order to raise the orientation selectivity of the oxide film 102 or to epitaxially grow the oxide film 102 easily, it is desirable that the oxide film 102 is formed while the substrate 101 is heated to a temperature of 700 degrees Celsius or more in such a manner that migration of the particles attached on the substrate 101 is promoted. Energy may be given to the particles by irradiating the substrate 101 with an ion beam to promote the migratation.

The method for forming the oxide film 102 is not limited to the sputtering method. An example of a different method for forming the oxide film 102 is a pulse laser deposition method (hereinafter, referred to as “PLD method”), a vacuum deposition method, an ion plating method, a chemical vapor deposition method (hereinafter, referred to as “CVD method”), or a molecular beam epitaxy method (hereinafter, referred to as “MBE method”).

Next, as shown in FIG. 5C, after the oxide film 102 has been formed, the oxide film 102 may be subjected to heat treatment under a vacuum atmosphere, if necessary. Desirably, the temperature of the heat treatment is 100 degrees Celsius or more higher than the temperature of the substrate 101 during the formation of the oxide film 102. This heat treatment decreases the value of a and the value of a/c. This is because this heat treatment increases, along the predetermined direction, the deformation of the crystal structure caused by the difference between the linear expansion coefficients of the substrate 101 and the oxide film 102.

After the formation of the oxide film 102, or after the heat treatment of the oxide film 102, the oxide film 102 is cooled down. Desirably, the oxide film 102 is cooled down to an ordinary temperature. Stress occurs in the oxide film 102 due to the difference between the linear expansion coefficients of the substrate 101 and the oxide film 102. For this reason, the perovskite crystal structure of the oxide is deformed. In this way, the oxide film 102 composed of the oxide having a deformed perovskite crystal structure is provided.

As shown in FIG. 5D, when the substrate 101 is formed of a material having a linear expansion coefficient of not less than 1×10⁻⁵/K and not more than 2×10⁻⁵/K, such as a MgO single-crystalline substrate, the oxide film 102 is affected by the compression stress. For this reason, the lattice constants are shortened along the in-plane direction of the oxide film 102 to raise the proton conductivity along the a-axis and the b-axis. See FIG. 2B.

On the other hand, as shown in FIG. 5C, when the substrate 101 is formed of a material having a linear expansion coefficient of not less than 1×10⁻⁶/K and not more than 4×10⁻⁶/K, such as a Si single-crystalline substrate, the oxide film 102 is affected by the tensile stress. For this reason, the lattice constant is shortened along the thickness direction of the oxide film 102 to raise the proton conductivity along the a-axis. See FIG. 2C. In this way, the oxide film 102 and the proton conductor 51 are obtained.

A buffer film may be interposed between the substrate 101 and the oxide film 102 to improve the crystallinity of the oxide film 102. The buffer film may be formed similarly to the case of the oxide film 102.

It is desirable that the oxide film 102 thus formed is an epitaxial film or an orientation film using the crystallinity of the substrate 101. When the crystallinity of the oxide film 102 is high, the high proton conductivity is obtained. More desirably, the oxide film 102 is single-crystalline.

As just described, the oxide which constitutes the oxide film 102 has a composition suitable for epitaxially growing or selectively orienting on the substrate 101.

As just described, the oxide film 102 is formed on the substrate 101 at a higher temperature than an ordinary temperature, and then, the oxide film 102 is cooled down to the ordinary temperature. Since the substrate 101 has a different linear expansion coefficient from that of the oxide film 102, after the oxide film 102 is cooled down, the oxide film 102 is affected by the compression stress or the tensile stress from the substrate 101 on the basis of the difference between the linear expansion coefficients of the material which constitutes the substrate 101 and the oxide which constitutes the oxide film 102. For this reason, the perovskite crystal structure of the oxide which constitutes the oxide film 102 is deformed along the predetermined direction.

As shown in FIG. 5D and FIG. 2B, in a case where the substrate 101 has a higher linear expansion coefficient than the oxide film 102 (for example, when the substrate 101 is a MgO substrate), after the oxide film 102 has been cooled down, the oxide film 102 is affected by the compression stress from the substrate 101. For this reason, the perovskite crystal structure is affected by the stress and deformed along the xy direction depicted in FIG. 1, namely, along the direction parallel to the oxide film 102, such that the unit cell of the perovskite crystal structure is shortened. As a result, as shown in FIG. 2B, the lattice constants a and b are smaller than the lattice constants a and b of the cubical system. On the other hand, the perovskite crystal structure is affected by the stress and deformed along the z direction depicted in FIG. 1, namely, along the thickness direction of the oxide film 102, such that the unit cell of the perovskite crystal structure is elongated. As a result, as shown in FIG. 2B, the lattice constant c is larger than the lattice constant c of the cubical system. In particular, in this case, the oxide film 102 shown in FIG. 1 exhibits the high proton conductivity along the in-plane direction of the film, namely, along the xy direction.

On the other hand, as shown in FIG. 5E and FIG. 2C, in a case where the substrate 101 has a smaller linear expansion coefficient than the oxide film 102 (for example, when the substrate 101 is a Si single-crystalline substrate), after the oxide film 102 has been cooled down, the oxide film 102 is affected by the tensile stress from the substrate 101. For this reason, the perovskite crystal structure is affected by the stress and deformed along the xy direction depicted in FIG. 1, namely, along the direction parallel to the oxide film 102, such that the unit cell of the perovskite crystal structure is elongated. As a result, as shown in FIG. 2C, the lattice constants b and c are larger than the lattice constants b and c of the cubical system. On the other hand, the perovskite crystal structure is affected by the stress and deformed along the z direction depicted in FIG. 1, namely, along the thickness direction of the oxide film 102, such that the unit cell of the perovskite crystal structure is shortened. As a result, as shown in FIG. 2C, the lattice constant a is smaller than the lattice constant a of the cubical system. In particular, the oxide film 102 shown in FIG. 1 exhibits the high proton conductivity along the thickness direction of the film, namely, along the z direction.

In FIG. 1, the oxide film 102 is supported on the substrate 101. However, the substrate 101 may be removed or peeled off from the oxide film 102. The deformed perovskite crystal structure of the oxide which constitutes the oxide film 102 is largely maintained, even after the substrate 101 has been removed. The oxide film 102 exhibits the high proton conductivity under a temperature of 200 degrees Celsius, even after the substrate 101 is removed or peeled off.

When the substrate 101 is formed of Si, a buffer film may be sandwiched between the substrate 101 and the oxide film 102. Desirably, the buffer film is formed of an oxide. By epitaxially growing the buffer film on the substrate 101, the orientation may be easily given to the oxide film 102 formed thereon, and the oxide film 102 may be epitaxially grown easily. An example of the material of the buffer film is MgO or SrRuO₃. An oxide thin film may be provided between the substrate 101 and the buffer film to epitaxially grow the MgO film or SrRuO₃ film easily. An example of the material of the oxide thin film is stabilized zirconia, CeO₂, or (La,Sr)MnO₃. Desirably, the buffer film has a thickness of not less than 5 nanometers and not more than 150 nanometers.

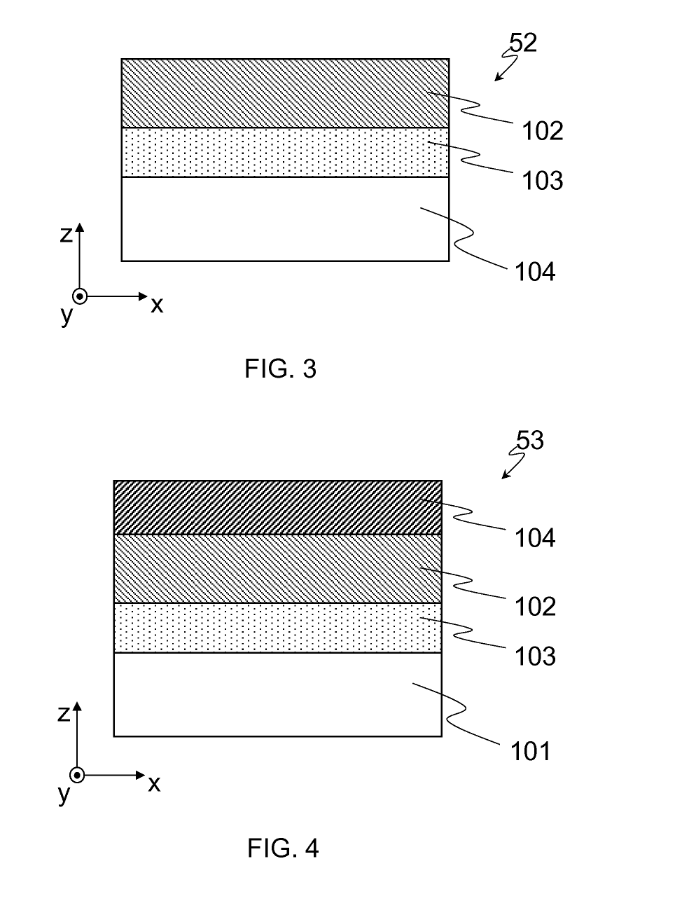

A mixed conductive oxide film having proton and electron conductivity may be provided on at least one principal plane of the oxide film 102. For example, a proton conductor 52 shown in FIG. 3 comprises the substrate 101, a mixed conductive oxide film 103 located on the substrate 101, and the oxide film 102. The mixed conductive oxide film 103 is interposed between the substrate 101 and the oxide film 102. The proton conductor 53 shown in FIG. 4 comprises the substrate 101, the first mixed conductive oxide film 103, the oxide film 102, and a second mixed conductive oxide film 104.

Since electrons and protons are capable of migrating simultaneously through the mixed conductive oxide film, the mixed conductive oxide film may be used suitably as a catalyst electrode in a case of using the oxide film 102 for a proton conductive device such as a hydrogenation device, a fuel cell, or a water vapor electrolysis device.

The mixed conductive oxide film also may have a perovskite crystal structure. Desirably, the material of the mixed conductive oxide film is a perovskite type oxide having proton and electron conductivity. In particular, for example, the material of the mixed conductive oxide film is composed of: at least one element selected from the group consisting of Ba, Sr, and Ca; at least one element selected from the group consisting of Zr, Hf, Y, La, Ce, Gd, In, Ga and Al; Ru; and O.

Similarly to the case of the oxide film 102, when the B site includes trivalent metal atoms, the proton conductivity is given to the mixed conductive oxide film. RuO₂ is a conductive oxide and exhibits metallic conductivity. For this reason, the mixed conductive oxide film including Ru has electronic conductivity. Similarly to the case of the oxide film 102, when the A site of the perovskite type oxide which constitutes the mixed conductive oxide film has a defect, the proton conductivity is significantly increased. The orientation selectivity of the mixed conductive oxide film is raised, and the mixed conductive oxide film is epitaxially grown easily. Desirably, the mixed conductive oxide film has a thickness of not less than 50 nanometers and not more than 500 nanometers.

When the mixed conductive oxide film is absent, a mesh electrode formed of a metal such as Pt, Au, Pd or Ag is formed on a principal plane of the oxide film 102 so as to be in contact with the oxide film 102. The mesh electrode has the same function as that of the mixed conductive oxide film. In other words, when the oxide film 102 is used for the proton conductive device, a proton-permeable or gas-permeable conductor may be provided on at least one principal plane of the oxide film 102.

### Second Embodiment

FIG. 6 shows a schematic view of a proton conductive device 54 according to the second embodiment. Similarly to the case shown in FIG. 4, the proton conductive device 54 comprises the substrate 101, the first mixed conductive oxide film 103 located on the substrate 101, the oxide film 102 located on the first mixed conductive oxide film 103, and the second mixed conductive oxide film 104 located on the oxide film 102. The oxide film 102 has a first principal plane 102a and a second principal plane 102b. The first principal plane 102a and the second principal plane 102b are in contact with the first mixed conductive oxide film 103 and the second mixed conductivity oxide film 104, respectively.

A first alumina pipe 304 is connected to the second mixed conductive oxide film 104. A gas supplied to the proton conductive device 54 through the first alumina pipe 304 reaches the first principal plane 102a. Similarly, a second alumina pipe 305 is connected to the substrate 101. A gas supplied to the proton conductive device 54 through the second alumina pipe 305 reaches the second principal plane 102b. A gas supplied to the first principal plane 102a through the first alumina pipe 304 may be different from the gas supplied to the second principal plane 102b through the second alumina pipe 305.

The substrate 101 is provided with plural holes 101h. The second principal plane 102b is exposed at the uppermost part of each of the holes 101h. Each of the holes 101h functions as a gas flow path.

A DC power supply 306 is connected electrically between the first mixed conductive oxide film 103 and the second mixed conductive oxide film 104 to apply an electric field to the first mixed conductive oxide film 102, the oxide film 102 and the second mixed conductive oxide film 104.

Hydrogen is supplied to the second mixed conductive oxide film 104 through the first alumina pipe 304 to supply hydrogen to the first principal plane 102a. A voltage of approximately 0.2V is applied between the first mixed conductive oxide film 103 and the second mixed conductive oxide film 104 using the DC power supply 306 so that a positive voltage is applied to the second mixed conductive oxide film 104. In this way, the hydrogen supplied to the first principal plane 102a penetrates the oxide film 102 as protons to reach the second principal plane 102b. As a result, the protons are extracted as hydrogen on the second principal plane 102b. The proton conductive device 54 is heated using a heater to 200 degrees Celsius and the hydrogen penetration property of the proton conductive device 54 is evaluated under a temperature of 200 degrees Celsius. Specifically, the hydrogen penetration property of the proton conductive device 54 can be evaluated by measuring an amount of hydrogen which has penetrated the proton conductive device 54 and extracted at the substrate 101 side using a gas chromatograph.

Water vapor is supplied to the oxide film 102 through the holes 101h, and a voltage of approximately 2V is applied between the first mixed conductive oxide film 103 and the second mixed conductive oxide film 104 using the DC power supply 306 so that a negative voltage is applied to the second mixed conductive oxide film 104. Protons are generated through electrolysis of the water vapor. The generated protons penetrate the oxide film 102, and are extracted as hydrogen on the second mixed conductive oxide film 104. Toluene is supplied to the second mixed conductive oxide film 104 through the first alumina pipe 304. The proton conductive device 54 is heated using a heater to 200 degrees Celsius to add hydrogen to toluene. As a result, methyl cyclohexane is obtained. In this case, the proton conductive device 54 functions as a hydrogenation device.

A voltage is applied between the first mixed conductive oxide film 103 and the second mixed conductive oxide film 104 using the DC power supply 306 so that a negative voltage is applied to the second mixed conductive oxide film 104. Methyl cyclohexane is supplied to the first alumina pipe 304. The proton conductive device 54 is heated using a heater to approximately 300 degrees Celsius. In this way, methyl cyclohexane is dehydrogenated to be toluene. In this case, the proton conductive device 54 functions as a dehydrogenation device.

### EXAMPLES

The present invention will be described with reference to the following examples.

### Inventive Example 1

In the inventive example 1, the oxide film 102 was fabricated as below.

A single-crystalline MgO substrate was prepared as the substrate 101. The MgO substrate had a surface which had been polished to a mirror gloss. The MgO substrate had a thickness of 0.5 millimeters, a diameter of 2 inches, and a (100) orientation.

The MgO substrate was disposed in a chamber of a sputtering device, and heated to 700 degrees Celsius. The chamber was under a gaseous mixture atmosphere of an Ar gas and an O₂ gas (Ar:O₂=8:2, volume ratio). The gaseous mixture had a pressure of 1 Pa.

A Ba_{0.6}Zr_{0.9}Y_{0.1}O_{2.55} film was formed as the oxide film 102 on the MgO substrate by a sputtering method using a high frequency (RF) power supply. The sputtering target had a composition represented by the chemical formula Ba_{0.6}Zr_{0.9}Y_{0.1}O_{2.55}. The sputtering target had a thickness of 4 millimeters and a diameter of 4 inches. The RF power was 150 W. The formed Ba_{0.6}Zr_{0.9}Y_{0.1}O_{2.55} film had a thickness of 1,000 nanometers.

As shown in FIG. 7, an impedance analyzer 201 was connected on the formed oxide film 102 using an Ag paste and an Au electric wire.

The oxide film 102 was isolated in a vacuum chamber. Using a heater installed outside the vacuum chamber, the vacuum chamber was heated to 200 degrees Celsius. Then, a gaseous mixture of an Ar gas and a hydrogen gas (Ar:H₂=95:5, volume ratio) was supplied to the vacuum chamber at a flow rate of 10 milliliters/minute. Electric conductivity (i.e., proton conductivity) of the oxide film 102 under an atmosphere of Ar:H₂=95:5 was measured using the impedance analyzer 201. In this way, the proton conductivity of the oxide film 102 was evaluated.

An activation energy (Eₐ) of the proton conductivity of the oxide film 102 was calculated as below.

First, the temperature of the vacuum chamber was set to 100 degrees Celsius. Then, similarly to the above case, the proton conductivity was measured using the impedance analyzer 201. Next, the temperature of the vacuum chamber was increased to 600 degrees Celsius and the proton conductivity at 200 degrees Celsius, 300 degrees Celsius, 400 degrees Celsius, 500 degrees Celsius and 600 degrees Celsius was measured.

Subsequently, the temperature of the vacuum chamber was decreased from 600 degrees Celsius to 100 degrees Celsius and the proton conductivity at 500 degrees Celsius, 400 degrees Celsius, 300 degrees Celsius, 200 degrees Celsius and 100 degrees Celsius was measured.

Furthermore, a graph showing a relation between the temperature and the proton conductivity was made using an Arrhenius equation (σ=A·exp(−Eₐ/kT), A: constant, Ea: activation energy for the proton conductivity, k: Boltzmann constant, T: temperature). For more detail, see Table 3 and FIG. 11 which were made in the inventive example 2.

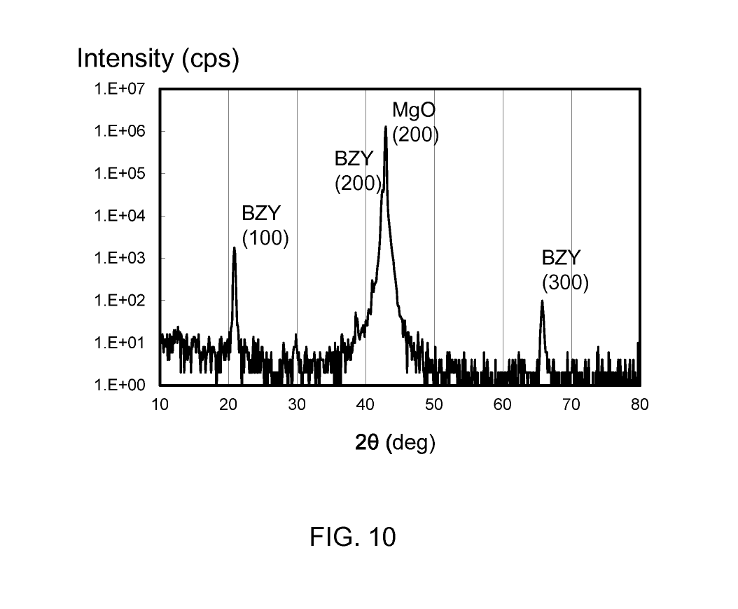

The formed Ba_{0.6}Zr_{0.9}Y_{0.1}O_{2.55} film was subjected to an X-ray diffraction analysis. FIG. 10 shows a result of the X-ray diffraction analysis. The Ba_{0.6}Zr_{0.9}Y_{0.1}O_{2.55} film had a significantly intense diffraction peak derived from the orientation of the substrate 101. In other words the Ba_{0.6}Zr_{0.9}Y_{0.1}O_{2.55} film had a (100) peak and peaks equivalent thereto only. In FIG. 10, the Ba_{0.6}Zr_{0.9}Y_{0.1}O_{2.55} film is described as “BZY”.

The lattice constants along the a-axis direction the c-axis direction were calculated on the basis of the X-ray diffraction results using the Bragg's law. In the inventive example 1, the a-axis of the Ba_{0.6}Zr_{0.9}Y_{0.1}O_{2.55} film was parallel to the substrate 101. On the other hand, the c-axis of the Ba_{0.6}Zr_{0.9}Y_{0.1}O_{2.55} film was perpendicular to the substrate 101.

### Inventive Example 2

The oxide film 102 was formed similarly to the inventive example 1, except that the sputtering target had a composition of Ba_{0.6}Zr_{0.9}Y_{0.1}O_{2.55}. The Ba_{0.6}Zr_{0.9}Y_{0.1}O_{2.55} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1. FIG. 11 is a graph showing the relation between the temperature and the proton conductivity in the inventive example 2. This graph was made using the Arrhenius equation. Table 3 shows the proton conductivity measured at a temperature of 100-600 degrees Celsius to make this graph.

### Inventive Example 3

The oxide film 102 was formed similarly to the inventive example 1, except that the sputtering target had a composition of Ba_{0.8}Zr_{0.7}Y_{0.3}O_{2.65}. The Ba_{0.8}Zr_{0.7}Y_{0.3}O_{2.65} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Inventive Example 4

The oxide film 102 was formed similarly to the inventive example 1, except that the sputtering target had a composition of Sr_{0.6}Zr_{0.5}Y_{0.5}O_{2.35}. The Sr_{0.6}Zr_{0.5}Y_{0.5}O_{2.35} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Inventive Example 5

The oxide film 102 was formed similarly to the inventive example 1, except that the sputtering target had a composition of Ca_{0.5}Zr_{0.6}Y_{0.4}O_{2.3}. The Ca_{0.5}Zr_{0.6}Y_{0.4}O_{2.3} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Inventive Example 6

The oxide film 102 was formed similarly to the inventive example 1, except that the sputtering target had a composition of Ca_{0.6}Zr_{0.8}Y_{0.2}O_{2.5}. The Ca_{0.6}Zr_{0.8}Y_{0.2}O_{2.5} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Inventive Example 7

The oxide film 102 was formed similarly to the inventive example 1, except that the sputtering target had a composition of Ca_{0.8}Zr_{0.9}Y_{0.1}O_{2.75}. The Ca_{0.8}Zr_{0.9}Y_{0.1}O_{2.75} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Inventive Example 8

The oxide film 102 was formed similarly to the inventive example 1, except that the sputtering target had a composition of Ba_{0.7}Zr_{0.8}Y_{0.2}O_{2.6}. The Ba_{0.7}Zr_{0.8}Y_{0.2}O_{2.6} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Inventive Example 9

The oxide film 102 was formed similarly to the inventive example 1, except that the sputtering target had a composition of Ba_{0.7}Zr_{0.4}Y_{0.6}O_{2.4}. The Ba_{0.7}Zr_{0.4}Y_{0.6}O_{2.4} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Inventive Example 10

The oxide film 102 was formed similarly to the inventive example 1, except that the sputtering target had a composition of Ba_{0.7}Zr_{0.3}Y_{0.7}O_{2.35}. The Ba_{0.7}Zr_{0.3}Y_{0.7}O_{2.35} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Inventive Example 11

The oxide film 102 was formed similarly to the inventive example 1, except that the sputtering target had a composition of Ba_{0.5}Zr_{0.8}Y_{0.2}O_{2.4}. The Ba_{0.5}Zr_{0.8}Y_{0.2}O_{2.4} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Inventive Example 12

The oxide film 102 was formed similarly to the inventive example 1, except that the sputtering target had a composition of Ba_{0.5}Zr_{0.6}Y_{0.4}O_{2.3}. The Ba_{0.5}Zr_{0.6}Y_{0.4}O_{2.3} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Inventive Example 13

The oxide film 102 was formed similarly to the inventive example 1, except that the sputtering target had a composition of Ba_{0.5}Zr_{0.5}Y_{0.5}O_{2.25}. The Ba_{0.5}Zr_{0.5}Y_{0.5}O_{2.25} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Inventive Example 14

The oxide film 102 was formed similarly to the inventive example 1, except that the sputtering target had a composition of Ba_{0.5}Zr_{0.4}Y_{0.6}O_{2.2}. The Ba_{0.5}Zr_{0.4}Y_{0.6}O_{2.2} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Inventive Example 15

The oxide film 102 was formed similarly to the inventive example 1, except that the sputtering target had a composition of Ba_{0.5}Zr_{0.3}Y_{0.7}O_{2.15}. The Ba_{0.5}Zr_{0.3}Y_{0.7}O_{2.15} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Inventive Example 16

The oxide film 102 was formed similarly to the inventive example 1, except that the sputtering target had a composition of Ba_{0.8}Zr_{0.6}Hf_{0.1}Y_{0.2}Ce_{0.1}O_{2.7}. In the inventive example 16, the oxide film 102 was not subjected to the heat treatment. Then, the proton conductivity, the activation energy, and the lattice constants of the oxide film 102 were measured and calculated similarly to the case of the inventive example 1.

### Inventive Example 17

The oxide film 102 was formed similarly to the inventive example 1, except that the sputtering target had a composition of Ba_{0.7}Zr_{0.5}In_{0.2}Y_{0.2}La_{0.1}O_{2.45}. In the inventive example 17, the oxide film 102 was not subjected to the heat treatment. Then, the proton conductivity, the activation energy, and the lattice constants of the oxide film 102 were measured and calculated similarly to the case of the inventive example 1.

### Inventive Example 18

The oxide film 102 was formed similarly to the inventive example 1, except that the sputtering target had a composition of Ba_{0.6}Zr_{0.4}Ga_{0.1}Y_{0.3}Gd_{0.2}O_{2.3}. In the inventive example 18, the oxide film 102 was not subjected to the heat treatment. Then, the proton conductivity, the activation energy, and the lattice constants of the oxide film 102 were measured and calculated similarly to the case of the inventive example 1.

### Inventive Example 19

The oxide film 102 was formed similarly to the inventive example 1, except that the sputtering target had a composition of Ba_{0.5}Zr_{0.3}Al_{0.1}Y_{0.3}Ce_{0.3}O_{2.3}. In the inventive example 19, the oxide film 102 was not subjected to the heat treatment. Then, the proton conductivity, the activation energy, and the lattice constants of the oxide film 102 were measured and calculated similarly to the case of the inventive example 1.

### Inventive Example 20

The oxide film 102 was formed similarly to the inventive example 1, except that the sputtering target had a composition of Ba_{0.5}Hf_{0.3}Al_{0.1}Y_{0.3}Ce_{0.3}O_{2.3}. In the inventive example 20, the oxide film 102 was not subjected to the heat treatment. Then, the proton conductivity, the activation energy, and the lattice constants of the oxide film 102 were measured and calculated similarly to the case of the inventive example 1.

### Inventive Example 21

The oxide film 102 was formed similarly to the inventive example 1, except that the sputtering target had a composition of Ba_{0.5}Zr_{0.3}Al_{0.1}Ce_{0.6}O_{2.45}. In the inventive example 21, the oxide film 102 was not subjected to the heat treatment. Then, the proton conductivity, the activation energy, and the lattice constants of the oxide film 102 were measured and calculated similarly to the case of the inventive example 1.

### Inventive Example 22

In the inventive example 22, the oxide film 102 was fabricated as below.

A single-crystalline Si substrate was prepared as the substrate 101. The Si substrate had a surface which had been polished to a mirror gloss. The Si substrate had a thickness of 0.5 millimeters, a diameter of 2 inches, a (100) orientation, and a specific resistance of 0.01 Ω·cm.

The Si substrate was disposed in a chamber of a sputtering device, and heated to 700 degrees Celsius. The chamber was under a gaseous mixture atmosphere of an Ar gas and an O₂ gas (Ar:O₂=8:2, volume ratio). The gaseous mixture had a pressure of 1 Pa.

A Ba_{0.8}Zr_{0.7}Y_{0.3}O_{2.65} film was formed as the oxide film 102 on the Si substrate by a sputtering method using a high frequency (RF) power supply. The sputtering target had a composition represented by the chemical formula Ba_{0.8}Zr_{0.7}Y_{0.3}O_{2.65}. The sputtering target had a thickness of 4 millimeters and a diameter of 4 inches. The RF power was 150 W. The formed Ba_{0.8}Zr_{0.7}Y_{0.3}O_{2.65} film had a thickness of 1,000 nanometers.

As shown in FIG. 8, an impedance analyzer 201 was connected on the formed oxide film 102 using an Ag paste and an Au electric wire.

Then, the proton conductivity, the activation energy, and the lattice constants of the oxide film 102 were measured and calculated similarly to the case of the inventive example 1. In the inventive example 22, the c-axis of the Ba_{0.8}Zr_{0.7}Y_{0.3}O_{2.65} film was parallel to the substrate 101. On the other hand, the a-axis of the Ba_{0.8}Zr_{0.7}Y_{0.3}O_{2.65} film was perpendicular to the substrate 101.

### Comparative Example 1

The oxide film 102 was formed similarly to the inventive example 1, except that the sputtering target had a composition of Ba_{1.0}Zr_{0.7}Y_{0.3}O_{2.85}, and except that the MgO substrate was heated to 400 degrees Celsius in the sputtering device. In the comparative example 1, the oxide film 102 was not subjected to the heat treatment. Then, the proton conductivity, the activation energy, and the lattice constants of the oxide film 102 were measured and calculated similarly to the case of the inventive example 1.

### Comparative Example 2

The oxide film 102 was formed similarly to the inventive example 1, except that the sputtering target had a composition of Ba_{0.9}Zr_{0.9}Y_{0.1}O_{2.85}, and except that the MgO substrate was heated to 400 degrees Celsius in the sputtering device. In the comparative example 2, the oxide film 102 was not subjected to the heat treatment. Then, the proton conductivity, the activation energy, and the lattice constants of the oxide film 102 were measured and calculated similarly to the case of the inventive example 1.

### Comparative Example 3

The oxide film 102 was formed similarly to the inventive example 1, except that the sputtering target had a composition of Ba_{1.0}Zr_{0.5}Y_{0.5}O_{2.75}. The Ba_{1.0}Zr_{0.5}Y_{0.5}O_{2.75} film obtained as the oxide film 102 was subjected to the heat treatment under a vacuum atmosphere of not more than 0.1 Pa under a temperature of 1,000 degrees Celsius for ten minutes. Then, the proton conductivity, the activation energy, and the lattice constants of the oxide film 102 were measured and calculated similarly to the case of the inventive example 1.

### Comparative Example 4

The oxide film 102 was formed similarly to the inventive example 22, except that the sputtering target had a composition of Ba_{1.0}Zr_{0.7}Y_{0.3}O_{2.85}, and except that the Si substrate was heated to 400 degrees Celsius in the sputtering device. In the comparative example 4, the oxide film 102 was not subjected to the heat treatment. Then, the proton conductivity, the activation energy, and the lattice constants of the oxide film 102 were measured and calculated similarly to the case of the inventive example 1.

The following Table 1 and Table 2 show the results of the inventive examples 1-22 and the comparative examples 1-4.

TABLE 1

| | | | Film formation | |
|---|---|---|---|---|
| | | | temperature | Heat |
| Sample | Film composition | Substrate | (Celsius) | treatment |
| Inventive | Ba_{0.6}Zr_{0.9}Y_{0.1}O_{2.55} | MgO(100) | 700 | No |
| example 1 | | | | |
| Inventive | Ba_{0.6}Zr_{0.9}Y_{0.1}O_{2.55} | MgO(100) | 700 | Yes |
| example 2 | | | | |
| Inventive | Ba_{0.8}Zr_{0.7}Y_{0.3}O_{2.65} | MgO(100) | 700 | Yes |
| example 3 | | | | |
| Inventive | Sr_{0.6}Zr_{0.5}Y_{0.5}O_{2.35} | MgO(100) | 700 | Yes |
| example 4 | | | | |
| Inventive | Ca_{0.5}Zr_{0.6}Y_{0.4}O_{2.3} | MgO(100) | 700 | Yes |
| example 5 | | | | |
| Inventive | Ca_{0.6}Zr_{0.8}Y_{0.2}O_{2.5} | MgO(100) | 700 | Yes |
| example 6 | | | | |
| Inventive | Ca_{0.8}Zr_{0.9}Y_{0.1}O_{2.75} | MgO(100) | 700 | Yes |
| example 7 | | | | |
| Inventive | Ba_{0.7}Zr_{0.8}Y_{0.2}O_{2.6} | MgO(100) | 700 | Yes |
| example 8 | | | | |
| Inventive | Ba_{0.7}Zr_{0.4}Y_{0.6}O_{2.4} | MgO(100) | 700 | Yes |
| example 9 | | | | |
| Inventive | Ba_{0.7}Zr_{0.3}Y_{0.7}O_{2.35} | MgO(100) | 700 | Yes |
| example 10 | | | | |
| Inventive | Ba_{0.5}Zr_{0.8}Y_{0.2}O_{2.4} | MgO(100) | 700 | Yes |
| example 11 | | | | |
| Inventive | Ba_{0.5}Zr_{0.6}Y_{0.4}O_{2.3} | MgO(100) | 700 | Yes |
| example 12 | | | | |
| Inventive | Ba_{0.5}Zr_{0.5}Y_{0.5}O_{2.25} | MgO(100) | 700 | Yes |
| example 13 | | | | |
| Inventive | Ba_{0.5}Zr_{0.4}Y_{0.6}O_{2.2} | MgO(100) | 700 | Yes |
| example 14 | | | | |
| Inventive | Ba_{0.5}Zr_{0.3}Y_{0.7}O_{2.15} | MgO(100) | 700 | Yes |
| example 15 | | | | |
| Inventive | Ba_{0.8}Zr_{0.6}Hf_{0.1}Y_{0.2}Ce_{0.1}O_{2.7} | MgO(100) | 700 | No |
| example 16 | | | | |
| Inventive | Ba_{0.7}Zr_{0.5}In_{0.2}Y_{0.2}La_{0.1}O_{2.45} | MgO(100) | 700 | No |
| example 17 | | | | |
| Inventive | Ba_{0.6}Zr_{0.4}Ga_{0.1}Y_{0.3}Gd_{0.2}O_{2.3} | MgO(100) | 700 | No |
| example 18 | | | | |
| Inventive | Ba_{0.5}Zr_{0.3}Al_{0.1}Y_{0.3}Ce_{0.3}O_{2.3} | MgO(100) | 700 | No |
| example 19 | | | | |
| Inventive | Ba_{0.5}Hf_{0.3}Al_{0.1}Y_{0.3}Ce_{0.3}O_{2.3} | MgO(100) | 700 | No |
| example 20 | | | | |
| Inventive | Ba_{0.5}Zr_{0.3}Al_{0.1}Ce_{0.6}O_{2.45} | MgO(100) | 700 | No |
| example 21 | | | | |
| Inventive | Ba_{0.8}Zr_{0.7}Y_{0.3}O_{2.65} | Si(100) | 700 | Yes |
| example 22 | | | | |
| Comparative | Ba_{1.0}Zr_{0.7}Y_{0.3}O_{2.85} | MgO(100) | 400 | No |
| example 1 | | | | |
| Comparative | Ba_{0.9}Zr_{0.9}Y_{0.1}O_{2.85} | MgO(100) | 400 | No |
| example 2 | | | | |
| Comparative | Ba_{1.0}Zr_{0.5}Y_{0.5}O_{2.75} | MgO(100) | 700 | Yes |
| example 3 | | | | |
| Comparative | Ba_{1.0}Zr_{0.7}Y_{0.3}O_{2.85} | Si(100) | 400 | No |
| example 4 | | | | |

TABLE 2

| | | | | Proton | |
|---|---|---|---|---|---|
| | | | | conductivity | |
| | | | | @ 200 | Proton |
| | Lattice | Lattice | | degrees | conduction |
| | constant | constant | | Celsius | Activation |
| Sample | a [nm] | c [nm] | a/c | [S/cm] | Energy [eV] |
| Inventive | 0.4172 | 0.4264 | 0.9784 | 0.05 | 0.053 |
| example 1 | | | | | |
| Inventive | 0.4154 | 0.4301 | 0.9658 | 0.09 | 0.044 |
| example 2 | | | | | |
| Inventive | 0.4163 | 0.4269 | 0.9752 | 0.21 | 0.038 |
| example 3 | | | | | |
| Inventive | 0.3971 | 0.4178 | 0.9505 | 0.26 | 0.052 |
| example 4 | | | | | |
| Inventive | 0.3915 | 0.4092 | 0.9567 | 0.32 | 0.047 |
| example 5 | | | | | |
| Inventive | 0.3890 | 0.4094 | 0.9502 | 0.15 | 0.063 |
| example 6 | | | | | |
| Inventive | 0.3892 | 0.3973 | 0.9796 | 0.07 | 0.057 |
| example 7 | | | | | |
| Inventive | 0.4156 | 0.4263 | 0.9749 | 0.23 | 0.029 |
| example 8 | | | | | |
| Inventive | 0.4187 | 0.4296 | 0.9746 | 0.20 | 0.033 |
| example 9 | | | | | |
| Inventive | 0.4190 | 0.4276 | 0.9799 | 0.08 | 0.043 |
| example 10 | | | | | |
| Inventive | 0.4149 | 0.4275 | 0.9705 | 0.22 | 0.041 |
| example 11 | | | | | |
| Inventive | 0.4158 | 0.4287 | 0.9699 | 0.31 | 0.053 |
| example 12 | | | | | |
| Inventive | 0.4160 | 0.4292 | 0.9692 | 0.27 | 0.046 |
| example 13 | | | | | |
| Inventive | 0.4163 | 0.4295 | 0.9693 | 0.19 | 0.037 |
| example 14 | | | | | |
| Inventive | 0.4165 | 0.4299 | 0.9688 | 0.08 | 0.045 |
| example 15 | | | | | |
| Inventive | 0.4145 | 0.4237 | 0.9783 | 0.12 | 0.031 |
| example 16 | | | | | |
| Inventive | 0.4133 | 0.4228 | 0.9775 | 0.13 | 0.026 |
| example 17 | | | | | |
| Inventive | 0.4130 | 0.4229 | 0.9766 | 0.13 | 0.040 |
| example 18 | | | | | |
| Inventive | 0.4124 | 0.4227 | 0.9756 | 0.14 | 0.055 |
| example 19 | | | | | |
| Inventive | 0.4122 | 0.4224 | 0.9759 | 0.11 | 0.058 |
| example 20 | | | | | |
| Inventive | 0.4189 | 0.4332 | 0.9670 | 0.10 | 0.056 |
| example 21 | | | | | |
| Inventive | 0.4180 | 0.4270 | 0.9789 | 0.13 | 0.036 |
| example 22 | | | | | |
| Comparative | 0.4263 | 0.4272 | 0.9979 | 1.00E−06 | 0.42 |
| example 1 | | | | | |
| Comparative | 0.4226 | 0.4243 | 0.9960 | 1.00E−05 | 0.35 |
| example 2 | | | | | |
| Comparative | 0.4184 | 0.4283 | 0.9769 | 5.00E−06 | 0.55 |
| example 3 | | | | | |
| Comparative | 0.4262 | 0.4271 | 0.9979 | 5.00E−07 | 0.40 |
| example 4 | | | | | |

TABLE 3

| Measured temperature (Celsius) | Proton conductivity (S/cm) |
|---|---|
| 100 | 0.069 |
| 200 | 0.088 |
| 300 | 0.104 |
| 400 | 0.127 |
| 500 | 0.145 |
| 600 | 0.161 |
| 500 | 0.147 |
| 400 | 0.122 |
| 300 | 0.108 |
| 200 | 0.090 |
| 100 | 0.068 |

As is clear from Table 1 and Table 2, the proton conductivity at the temperature of 200 degrees Celsius in the inventive examples 1-22 is 7,000 times-620,000 times higher than that of the comparative examples 1-4.

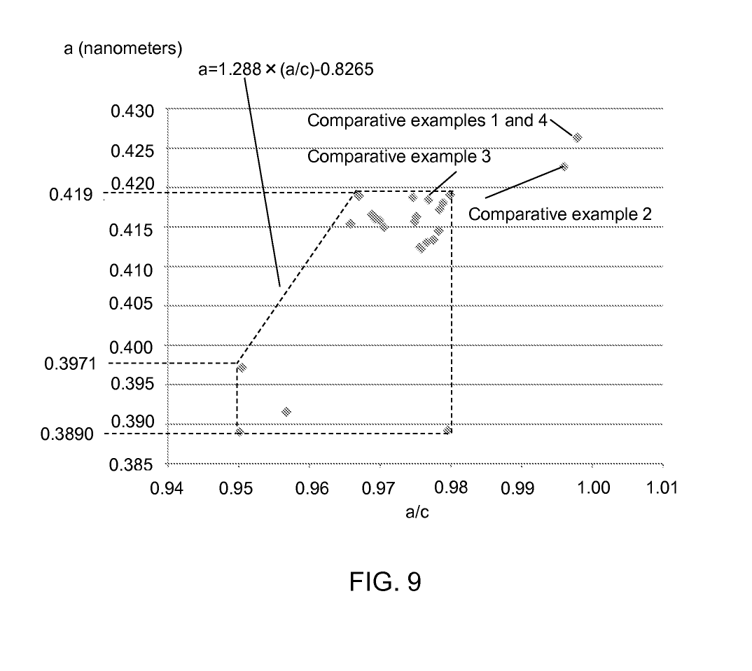

FIG. 9 shows a graph showing a relation between the value of a/c and the value of a. As understood from FIG. 9, the following mathematical formulae (IV) and (V) are satisfied in the inventive examples 1-22.

0.3890 nanometers≦a≦0.4190 nanometers (IV)

0.95≦a/c<0.98 (V)

The minimum conductivity required for the operation of a fuel cell is 0.01 S/cm. In the inventive examples 3-6, 8, 9, 11-14, and 16-22, the proton conductivity is more than 0.1 S/cm. Accordingly, in these inventive examples, the proton conductivity is ten times or more higher than the minimum conductivity and thereby the good proton conductivity is exhibited. In these inventive examples, the following mathematical formula (IIb) is satisfied.

0.2≦y≦0.6 (IIb)

In the inventive examples 4, 5, 12, and 13, the proton conductivity is more than 0.25 S/cm. For this reason, in these inventive examples, better proton conductivity is exhibited. In these inventive examples, all of the following three mathematical formulae are satisfied.

0.3≦x≦0.5 (Ia)

0.3≦y≦0.5 (IIa)

a≦2.5 (IIIa)

In these inventive examples, the heat treatment was performed.

As is clear from Table 1 and Table 2, the activation energy for the proton conductivity in the inventive examples 1-22 is approximately one-tenth times as much as that of the comparative examples 1-4. This means that the oxide films according to the inventive examples have smaller temperature dependence of the proton conductivity than the oxide films according to the comparative examples, and that they have the high proton conductivity within a broad temperature range. For this reason, the oxide film according to the embodiment would exhibit better proton conductivity than a conventional oxide film not only at 200 degrees Celsius but also within the low temperature range of approximately 150-250 degrees Celsius, for example.

In the inventive examples 1-22, the crystallinity of the oxide film 102 was gradually decreased with an increase in the thickness of the oxide film 102. When the oxide film 102 had a thickness more than 5 micrometers, the proton conductivity at 200 degrees Celsius was decreased to less than 0.001 S/cm. For this reason, it is desirable that the oxide film 102 has a thickness of not more than 5 micrometers.

In the inventive examples 1-22, the substrate 101 was removed by a wet-etching method using phosphoric acid. Then, the proton conductivity of the oxide film 102 was measured. The measured proton conductivity after the substrate was removed was substantially equal to the measured proton conductivity before the substrate was removed. This means that the deformed crystal structure was maintained in the oxide film 102 even after the substrate 101 was removed.

The proton conductive device 54 according to the second embodiment was fabricated using the oxide film 102 according to the inventive examples 1-22. Then, the hydrogen penetration property under a temperature of 200 degrees Celsius was evaluated. As a result, the proton conductive devices 54 having the oxide films 102 according to the inventive examples 1-22 had a 1,000 times or more higher hydrogen penetration property than that of the comparative examples 1-4. This means that the oxide films 102 according to the inventive examples 1-22 have a significantly good hydrogen penetration property under a lower temperature than the temperature under which a conventional perovskite oxide is generally used.

### INDUSTRIAL APPLICABILITY

The oxide film and the proton conductor according to the present invention can be used for a hydrogenation device, a fuel cell, and a water vapor electrolysis device. The oxide film and the proton conductor according to the present invention can also be used for a device such as a hydrogen sensor.

### REFERENTIAL SIGNS LIST

52 proton conductor
53 proton conductor
54 proton conductive device
101 substrate
101a principal plane of the substrate 101
101h hole
102 oxide film
102a first principal plane
102b second principal plane
103 first mixed conductive oxide film
104 second mixed conductive oxide film
201 impedance analyzer
304 first alumina pipe
305 second alumina pipe
306 DC power supply

1. An oxide film composed of an oxide having a perovskite crystal structure, wherein
the oxide is represented by a chemical formula A₁₋ₓ(E_{1-y}G_{y})O_{z};
where
A represents at least one element selected from the group consisting of Ba, Sr, and Ca;
E represents at least one element selected from the group consisting of Zr, Hf, In, Ga, and Al;
G represents at least one element selected from the group consisting of Y, La, Ce, and Gd; and
all of the following five mathematical formulae (I)-(V) are satisfied:
0.2≦x≦0.5 (I)
0.1≦y≦0.7 (II)
z<3 (III)
0.3890 nanometers≦a≦0.4190 nanometers (IV)
0.95≦a/c<0.98 (V)
where
each of a, b and c represents a lattice constant of the perovskite crystal structure; and
either the following mathematical formula (VIa) or (VIb) is satisfied:
a≦b<c (VIa)
a<b≦c (VIb).

2. The oxide film according to claim 1, wherein
the oxide film has a (100) or (001) orientation.

3. The oxide film according to claim 1, wherein
the oxide film has a thickness of not more than 5 micrometers.

4. The oxide film according to claim 1, wherein
both of the following two mathematical formulae (IVa) and (Va) are further satisfied:
0.3890 nanometers≦a≦0.4040 nanometers (IVa)
0.95≦a/c<0.975 (Va).

5. The oxide film according to claim 1, wherein
the following mathematical formula (IIb) is further satisfied:
0.2≦y≦0.6 (IIb).

6. The oxide film according to claim 1, wherein
all of the following three mathematical formulae (Ia), (IIa), and (IIIa) are further satisfied:
0.3≦x≦0.5 (Ia)
0.3≦y≦0.5 (IIa)
z≦2.5 (IIIa).

7. A proton conductor, comprising:
a single-crystalline substrate; and
an oxide film disposed on or above the single-crystalline substrate, wherein
the oxide film is the oxide film according to claim 1.

8. The proton conductor according to claim 7, wherein
the single-crystalline substrate has a larger linear expansion coefficient than the oxide film.

9. The proton conductor according to claim 8, wherein
the single-crystalline substrate is formed of magnesium oxide.

10. The proton conductor according to claim 7, wherein
the single-crystalline substrate has a smaller linear expansion coefficient than the oxide film.

11. The proton conductor according to claim 10, wherein
the single-crystalline substrate is formed of silicon.

12. A proton conductor, comprising:
an oxide film; and
a proton-permeable or gas-permeable conductive material provided on at least one surface of the oxide film, wherein
the oxide film is the oxide film according to claim 1.
